(19) United States
(12) Patent Application Publication
(10) Pub. No.: US 2024/0409129 A1
(43) Pub. Date: Dec. 12, 2024

(54) OPERATION METHOD AND OPERATION SYSTEM FOR UPPER AND LOWER DOUBLE-DUCT JET-PROPELLED PIPELINE ULTRA-HIGH SPEED FLYING VEHICLE

(71) Applicant: North University of China, Taiyuan City (CN)

(72) Inventors: Tiehua MA, Taiyuan City (CN); Kun ZHANG, Taiyuan City (CN); Yaoyan WU, Taiyuan City (CN); Changxin CHEN, Taiyuan City (CN); Lei FENG, Taiyuan City (CN)

(73) Assignee: North University of China, Taiyuan City (CN)

(21) Appl. No.: 18/428,114

(22) Filed: Jan. 31, 2024

(30) Foreign Application Priority Data
Jun. 7, 2023 (CN) 202310664944.8

(51) Int. Cl. B61B 13/08; B60V 3/04; B61B 13/10

(52) U.S. Cl. CPC B61B 13/08; B60V 3/04; B61B 13/10

(57) ABSTRACT

A head propeller of the flying vehicle compresses incoming flow at a vehicle head inside an upper duct to a lower duct through an air suction channel. A portion of airflow is compressed to the lower duct through the air suction channel under an action of a guide plate and a vehicle body propeller. A bottom propeller of the flying vehicle compresses an airflow into pressure bins of the lower duct at a lower portion through the air suction channel. A sealing state of the pressure bins of the lower duct is destroyed. High-pressure airflow inside the lower duct is jetted out from an air outlet channel to the upper duct. A tail propeller guides the airflow to the tail portion of the vehicle body. The upper duct and the lower duct are constructed inside the pipeline, so a running resistance of the flying vehicle is reduced.

### TECHNICAL FIELD

The invention relates to a technical field of rail transit, in particular to an operation method and an operation system for an upper and lower double-duct jet-propelled pipeline ultra-high speed flying vehicle.

### BACKGROUND OF THE INVENTION

The development of the ultra-high speed flying vehicle mainly needs to solve two major problems of reducing resistance and controlling noise. The existing solution is to eliminate wheel-rail friction resistance and weaken pneumatic resistance through a low vacuum pipeline magnetic suspension electromagnetic propulsion technology. Noise may be controlled inside the pipeline through pipeline constraint, such that the influence of noise along a line is greatly reduced, but meanwhile, the low vacuum pipeline weakens pneumatic effect, and the expense expenditure in multiple aspects such as pipeline construction, low vacuum maintenance, later maintenance and the like is greatly increased. The low vacuum pipeline has many disadvantages in emergency escape, emergency rescue and daily maintenance. There are also many technical difficulties in supplying power to the ultra-high speed vehicle body, and using batteries for electricity storage may lead to weight issues.

Aiming at the above problems, the invention provides an operation method and an operation system for an upper and lower double-duct jet-propelled pipeline ultra-high speed flying vehicle for realizing jet-propelled ultra-high speed flight through air floatation and air inflation of the upper and lower double ducts under the normal atmospheric pressure without low vacuum and magnetic levitation electromagnetic propulsion technologies.

### SUMMARY OF THE INVENTION

The invention provides an operation method and an operation system for an upper and lower double-duct jet-propelled pipeline ultra-high speed flying vehicle for solving the technical difficulty of a low vacuum pipeline used in the existing ultra-high speed flying vehicle.

The invention is realized by the following technical solution: an operation method for an upper and lower double-duct jet-propelled pipeline ultra-high speed flying vehicle, wherein
S1: a space inside a pipeline is divided into an upper duct and a lower duct by a bottom plate in the pipeline, and the lower duct below the bottom plate is divided into a plurality of pressure bins by a partition plate; a flying vehicle runs in the upper duct, and an air suction channel and an air outlet channel which communicate the pressure bins with the upper duct are disposed in the bottom plate along a running direction;
S2: the operation method comprises air sucking, compressing, and air jetting;
during the air sucking, a head propeller of the flying vehicle compresses most of incoming flow at a vehicle head inside the upper duct to the lower duct through the air suction channel; a small portion of airflow at the vehicle head is compressed to the lower duct through the air suction channel under an action of a guide plate and a vehicle body propeller at a vehicle body of the flying vehicle; and an airflow in a gap between a top of the flying vehicle and the pipeline is restrained by the gap and is always in a laminar flow state;
during the compressing, a bottom propeller of the flying vehicle compresses an airflow into the pressure bins of the lower duct at a lower portion of the flying vehicle through the air suction channel, and a power provided by the bottom propeller supplements energy loss in a flowing of the airflow and enables the pressure bins of the lower duct to be in a dynamic sealing state;
during the air jetting, the dynamic sealing state of the pressure bins of the lower duct located at a tail portion of the flying vehicle is destroyed, high-pressure airflow inside the lower duct is jetted out from the air outlet channel to the upper duct along the tail portion of the flying vehicle, and a tail propeller of the flying vehicle guides the airflow to the tail portion of the vehicle body, achieving a running of the flying vehicle at an ultra-high speed in the pipeline.

The invention also provides an operation system for an upper and lower double-duct jet-propelled pipeline ultra-high speed flying vehicle, wherein the operation system comprises a pipeline and a flying vehicle;
the pipeline comprises a bottom plate which is disposed inside a pipeline body and divides a space inside the pipeline into an upper duct and a lower duct, the lower duct below the bottom plate is divided into a plurality of pressure bins by a partition plate, an edge of the bottom plate is in sealing connection with the pipeline body of the pipeline, and a first opening allowing airflow to come in and go out is disposed in a middle of the bottom plate along a running direction, the first opening being used as both an air suction channel and an air outlet channel which communicate the pressure bins with the upper duct;
the flying vehicle comprises a vehicle body with a side view projection being similar to a parallelogram and a front view projection being semicircular, a head tip of the vehicle body gradually increases in width and transits to the vehicle body when seen from a top view direction, a tail of the vehicle body gradually reduces in width from the vehicle body, the head tip of the vehicle body is located at a lower portion of the vehicle body, two head propellers are symmetrically disposed side by side in the middle of a head of the vehicle body, two tail propellers are symmetrically disposed side by side in the middle of a tail of the vehicle body, a plurality of guide plates are disposed side by side at a side edge of the vehicle body along front-rear direction, a guide gap is formed between a plate body of the guide plates and a vehicle body surface of the vehicle body, a joint between the plate body of the guide plates and the vehicle body surface of the vehicle body is gradually inclined towards the tail from up to down, the plate body of the guide plates gradually increases in width from up to down, an airflow inlet of the guide gap faces a head of the vehicle body, the guide gap gradually increases in width from up to down; at least two vehicle body propellers are disposed inside the guide gap, two rows of bottom propellers are disposed side by side at a bottom of the vehicle body along the front-rear direction, and a width of the vehicle body occupied by the two rows of bottom propellers together is matched with the first opening.

As a further improvement of the technical solution of the operation system in the invention, two rows of wheels are disposed side by side at the bottom of the vehicle body along the front-rear direction, the bottom plate close to the first opening is inclined downwards towards a center of the first opening, and the two rows of wheels are able to support and mate at an inclined position of the bottom plate.

As a further improvement of the technical solution of the operation system in the invention, the two head propellers each have a propeller body with two symmetrical forward and reverse paddles, and the propeller bodies of the two head propellers are located in the same plane, the plane where the propeller bodies of the two head propellers are located is perpendicular to a length direction of the vehicle body, and the plane where the propeller bodies of the two head propellers are located is perpendicular to the bottom plate.

As a further improvement of the technical solution of the operation system in the invention, the two tail propellers each have a propeller body with two symmetrical forward and reverse paddles, and the propeller bodies of the two tail propellers are located in the same plane, there is an angle between the plane where the propeller bodies of the two tail propellers are located and the bottom plate, and lower portions of the propeller bodies of the two tail propellers are inclined towards the head of the vehicle body.

As a further improvement of the technical solution of the operation system in the invention, the two rows of bottom propellers are symmetrically disposed at a central position of the bottom of the vehicle body, propeller bodies of the same row of bottom propellers are located in the same plane, there is an angle between the planes where the propellers bodies of the two rows of bottom propellers are located, and the angle between the planes where the propellers bodies of the two rows of bottom propellers are located is disposed to be narrow at upper and wide at lower.

The invention also provides another operation system for an upper and lower double-duct jet-propelled pipeline ultra-high speed flying vehicle, wherein the operation system comprises a pipeline and a flying vehicle;
the pipeline comprises a bottom plate which is disposed inside a pipeline body and divides a space inside the pipeline into an upper duct and a lower duct, the lower duct below the bottom plate is divided into a plurality of pressure bins by a partition plate, a spacing between an edge of the bottom plate and the pipeline body of the pipeline forms an air suction channel which communicates the pressure bins with the upper duct, and a second opening allowing airflow to flow out from the pressure bins to the upper duct is disposed in a middle of the bottom plate along a running direction, the second opening being used as an air outlet channel which communicates the pressure bins with the upper duct;
the flying vehicle comprises a vehicle body with a side view projection being similar to a parallelogram and a front view projection being semicircular, a head tip of the vehicle body gradually increases in width and transits to the vehicle body when seen from a top view direction, a tail of the vehicle body gradually reduces in width from the vehicle body, the head tip of the vehicle body is located at a lower portion of the vehicle body, two head propellers are symmetrically disposed side by side in the middle of a head of the vehicle body, two tail propellers are symmetrically disposed side by side in the middle of a tail of the vehicle body, a plurality of guide plates are disposed side by side at a side edge of the vehicle body along front-rear direction, a joint between a plate body of the guide plates and a vehicle body surface of the vehicle body is gradually inclined towards the tail from up to down, the joint between the plate body of the guide plates and the vehicle body surface of the vehicle body gradually reduces in width from up to down, a guide plane that the plate body of the guide plates forms gradually increases from up to down, at least one vehicle body propeller is disposed in front of the vehicle body corresponding to the guide plates, a row of bottom propellers is separately disposed at a bottom of the vehicle body outside both sides of the vehicle body along the front-rear direction, and the two rows of bottom propellers are respectively located corresponding to the air suction channel.

As a further improvement of the technical solution of the operation system in the invention, two rows of wheels are disposed side by side at the bottom of the vehicle body along the front-rear direction, and the two rows of wheels are able to respectively support and mate with the bottom plate at both sides of the second opening.

As a further improvement of the technical solution of the operation system in the invention, the two head propellers each have a propeller body with two symmetrical forward and reverse paddles, the propeller bodies of the two head propellers are located in the same plane, and there is an obtuse angle between the planes where the propeller bodies of the two head propellers are located and an advancing direction of the vehicle body.

As a further improvement of the technical solution of the operation system in the invention, the two tail propellers each have a propeller body with two symmetrical forward and reverse paddles, the propeller bodies of the two tail propellers are located in the same plane, and there is an obtuse angle between the planes where the propeller bodies of the two tail propellers are located and an advancing direction of the vehicle body.

Compared with the prior art, the operation method and the operation system for an upper and lower double-duct jet-propelled pipeline ultra-high speed flying vehicle in the invention have the following advantageous effects:

1. The upper duct and the lower duct are constructed inside the pipeline, so that the airflow is effectively organized, the running resistance of the flying vehicle is reduced, and the operation efficiency of the ultra-high speed flying vehicle is improved.

2. The layout of the propeller with the distributed electric propulsion technology (DEP) is more flexible in space, and when coordinated with the upper and lower ducts in the pipeline, it may realize larger air intake with smaller compression ratio.

3. The boundary layer ingestion technology and the air-float membrane technology are realized by the distributed electric propulsion technology (DEP), so that the airflow resistance of the side and the top of the vehicle body is effectively reduced.

4. The flying vehicle may run at an ultra-high speed in a normal pressure pipeline, and may be connected with the existing railway network, thereby reducing the construction cost and the operation cost.

5. The hydrogen electricity technology may be applied to the present invention, with high low-carbon and environmental protection values. The present invention possesses the characteristics of low hydrogen volume energy density and high mass density; only water vapor is discharged in the pipeline by the hydrogen electricity technology with zero emissions of polluted and harmful gases, which will not accumulate in pipelines, and cause harm to passengers; the hydrogen electricity device may be designed integrally with the tail of the vehicle, and a large amount of gas and hydrogen electricity technology exhaust are mixed and discharged, which facilitates the fully utilization of the waste heat from power generation to do work.

6. The present invention avoids the influence of weather, possesses high intrinsic safety, better controls noise through pipeline, realizes all-weather full-period operation, and is highly time-efficient.

### BRIEF DESCRIPTION OF THE DRAWINGS

The drawings herein, which are incorporated in and constitute a portion of the description, illustrate embodiments consistent with the invention, and serve to explain the principles of the invention together with the description.

In order to more clearly illustrate the embodiments of the invention or the technical solutions of the prior art, the drawings which are used in the description of the embodiments or the prior art will be briefly described, and it will be obvious to those skilled in the art that other drawings may be obtained from these drawings without inventive effort.

FIG. 1 is a side view of the vehicle body according to Embodiment 1 of the invention.

FIG. 2 is a top view of FIG. 1.

FIG. 3 is a bottom view of FIG. 1.

FIG. 4 is a schematic view showing the structure of the vehicle body according to Embodiment 1 of the invention.

FIG. 5 is a right side view of FIG. 1.

FIG. 6 is a left side view of FIG. 1.

FIG. 7 is a longitudinal sectional view of the pipeline according to Embodiment 1 of the invention in the length direction.

FIG. 8 is a cross-sectional view of the pipeline according to Embodiment 1 of the invention.

FIG. 9 is a radial longitudinal sectional view of the pipeline according to Embodiment 1 of the invention.

FIG. 10 is a schematic diagram of the airflow running around the vehicle body according to Embodiment 1 of the invention.

FIG. 11 is a schematic diagram of the airflow around the head of the vehicle body according to Embodiment 1 of the invention.

FIG. 12 is a schematic diagram of the airflow around the tail of the vehicle body according to Embodiment 1 of the invention.

FIG. 13 is a side view of the vehicle body according to Embodiment 2 of the invention.

FIG. 14 is a schematic view showing the structure of the vehicle body according to Embodiment 2 of the invention.

FIG. 15 is a bottom view of the vehicle body according to Embodiment 2 of the invention.

FIG. 16 is another schematic view showing the structure of the vehicle body according to Embodiment 2 of the invention.

FIG. 17 is a left side view of FIG. 13.

FIG. 18 is a right side view of FIG. 13.

FIG. 19 is an enlarged view of a portion of the bottom propeller in FIG. 17.

FIG. 20 is a longitudinal sectional view of the pipeline according to Embodiment 2 of the invention in the length direction.

FIG. 21 is a cross-sectional view of the pipeline according to Embodiment 2 of the invention.

FIG. 22 is a radial longitudinal sectional view of the pipeline according to Embodiment 2 of the invention.

FIG. 23 is a schematic diagram of the airflow running around the vehicle body according to Embodiment 2 of the invention.

FIG. 24 is a schematic diagram (side view) of the airflow running around the vehicle body according to Embodiment 2 of the invention.

In the drawings: 1—pipeline, 101—bottom plate, 102—partition plate, 103—first opening, 104—second opening, 2—flying vehicle, 201—vehicle body, 202—head propeller, 203—guide plate, 204—vehicle body propeller, 205—bottom propeller, 206—tail propeller, 207—wheel, 208—tail guide plate, 209—first arc-shaped concave surface, 210—second arc-shaped concave surface.

### DETAILED DESCRIPTION OF THE INVENTION

In order that the above objects, features and advantages of the invention will be more clearly understood, a further description of the solutions of the invention will be made. It should be noted that, without conflict, the embodiments of the invention and features in the embodiments may be combined with each other.

In the description, it should be noted that the terms “first” and “second” are used for descriptive purposes only and are not to be construed as indicating or implying relative importance. It should be noted that, unless explicitly stated or defined otherwise, the terms “mounted,” “interconnected,” and “connected” are to be construed broadly, and may be, for example, fixedly connected, detachably connected, or integrally connected; may be directly connected or indirectly connected through an intermediate medium, or may be communication inside two elements. The specific meaning of the terms described above will be understood by those skilled in the art as the case may be.

In the following description, numerous specific details are set forth in order to provide a thorough understanding of the invention, but the invention may be implemented otherwise than as described herein; it will be apparent that the embodiments in the description are only some, but not all of the embodiments of the invention.

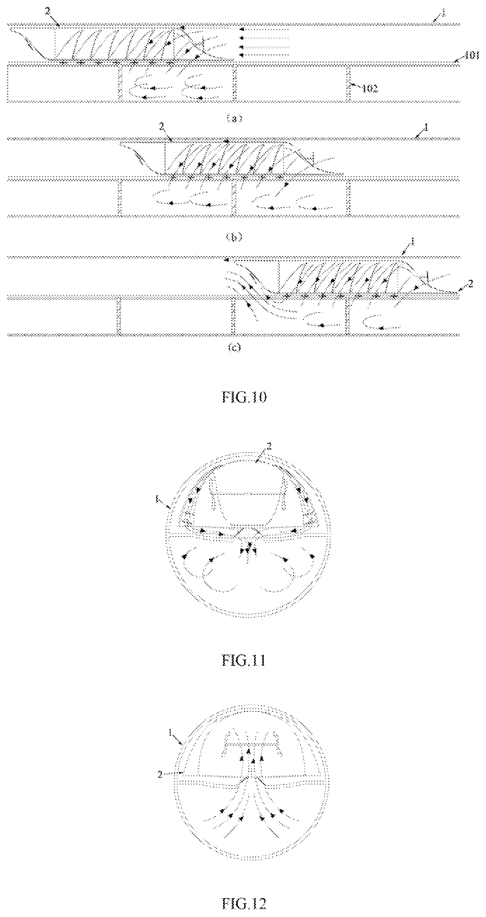

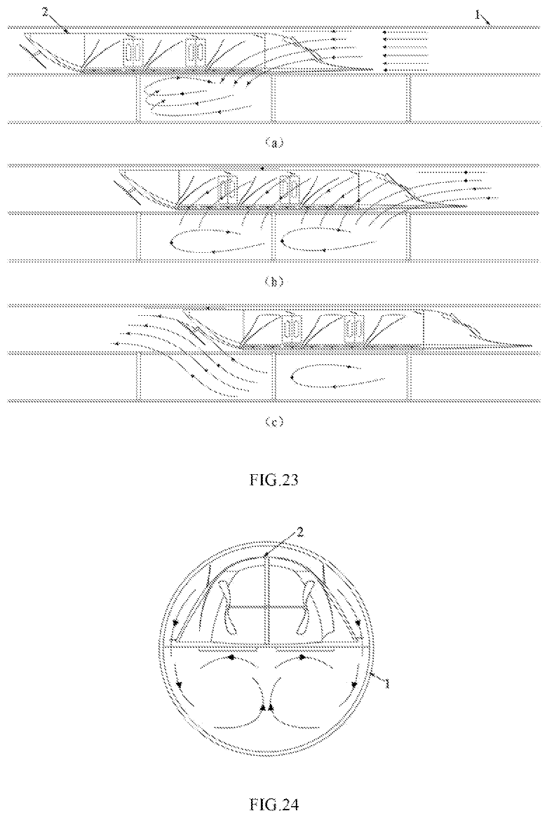

The invention provides an operation method for an upper and lower double-duct jet-propelled pipeline ultra-high speed flying vehicle, specifically:
S1: as shown in FIG. 20, a space inside a pipeline 1 is divided into an upper duct and a lower duct by a bottom plate 101 in the pipeline 1, and the lower duct below the bottom plate 101 is divided into a plurality of pressure bins by a partition plate 102; a flying vehicle 2 runs in the upper duct, and an air suction channel and an air outlet channel which communicate the pressure bins with the upper duct are disposed in the bottom plate 101 along a running direction;
S2: the operation method comprises air sucking, compressing, and air jetting (as shown in FIGS. 10 and 23);
during the air sucking, a head propeller 202 of the flying vehicle 2 compresses most of incoming flow at a vehicle head inside the upper duct to the lower duct through the air suction channel; a small portion of airflow at the vehicle head is compressed to the lower duct through the air suction channel under an action of a guide plate 203 and a vehicle body propeller 204 at a vehicle body of the flying vehicle 2; and the airflow in a gap between a top of the flying vehicle 2 and the pipeline 1 is restrained by the gap and is always in a laminar flow state (due to the space condition that no vortex and turbulence can be formed therefrom);
during the compressing, a bottom propeller 205 of the flying vehicle 2 compresses an airflow into the pressure bins of the lower duct at a lower portion of the flying vehicle 2 through the air suction channel, and a power provided by the bottom propeller 205 supplements energy loss in a flowing of the airflow and enables the pressure bins of the lower duct to be in a dynamic sealing state; during the air jetting, the dynamic sealing state of the pressure bins of the lower duct located at a tail portion of the flying vehicle 2 is destroyed, high-pressure airflow inside the lower duct is jetted out from the air outlet channel to the upper duct along the tail portion of the flying vehicle 2, and a tail propeller 206 of the flying vehicle 2 guides the airflow to the tail portion of the vehicle body, achieving a running of the flying vehicle 2 at an ultra-high speed in the pipeline 1.

In the invention, the incoming flow corresponds to an airflow, and particularly refers to an airflow that rushes against a head portion of the flying vehicle 2. The air suction channel and the air outlet channel may be the same channel or different channels. And the air suction channel and the air outlet channel may be one channel or a plurality of channels.

In the non-operating state, the inside of the pipeline 1 in the invention is in an atmospheric environment. Problems such as the technical difficulty of the low vacuum pipeline, and expenditure, etc., are solved.

In the invention, in the process of guiding the airflow towards the vehicle body portion by the guide plate 203, the guide plate 203 and the vehicle body propeller 204 change the transition point of the airflow in the process of flowing around the vehicle body through the boundary layer ingestion technology, so that the airflow is always in ordered laminar flow in the process of being compressed to the lower duct. When the flying vehicle 2 disturbs the airflow inside the pipeline 1, the airflow inside the pipeline is in a relatively static state, and when the flying vehicle 2 is in operation, the airflow in a gap between the top of the flying vehicle 2 and the pipeline 1 is restrained by the gap, and the airflow restrained by the gap and in a laminar flow state forms an air-float membrane on the surface of the flying vehicle.

During the air sucking, the airflow at the vehicle head of the flying vehicle 2 is introduced into the lower duct, so that the pressure intensity of the airflow at the vehicle head of the flying vehicle 2 is reduced; during the compressing, the pressure intensity of the airflow inside the lower duct is increased; during the air jetting, the pressure intensity of the airflow at the vehicle tail of the flying vehicle 2 is increased, so that pressure intensity difference exists between the vehicle head and the vehicle tail of the flying vehicle 2 in the whole process, and the pressure intensity at the vehicle tail of the flying vehicle 2 is higher than that at the vehicle head of the flying vehicle 2; there is a pressure intensity difference between the bottom of the vehicle body 201 and the top of the vehicle body 201, and the pressure intensity at the bottom of the vehicle body 201 is higher than that at the top of the vehicle body 201.

The lift-drag ratio of the flying vehicle 2 in the pipeline 1 in the invention is estimated as follows:
the dimensions and load of the flying vehicle 2 are as follows: the vehicle height is 2.5 m, the width is 3 m, the dead weight is 10 t, the rated load is 100 people, and the full load weight is 20 t; during self-steady operation of the flying vehicle 2, the lift force L is balanced with the gravity G at full load, i.e.:

$$L = G = Mg = 20000 kg * 9.8 N / kg = 196000 N$$

under the self-steady operation, the flying vehicle 2 is in a steady operation state, the resistance is balanced with the aerodynamic force, the aerodynamic force of the flying vehicle 2 is provided by the front-rear pressure difference of the vehicle body 2, and since the cross section of the vehicle body of the flying vehicle 2 is in an irregular shape, the cross section area S is estimated to be 7 m², the pressure difference ΔP of the front and rear atmosphere of the vehicle head is 0.01 bar, the power F generated by the pressure difference ΔP is as follows: F=ΔPS, and the power F is equal in value to the resistance D, i.e.: F=D; the resistance D is:

$$D = F = Δ PS = 0.01 bar * 7 {m}^{2} = 0.01 * 101325 pa * 7 = 7092.75 N$$

the lift-drag ratio is:

$$K = L / D = 27.6339 \approx 28$$

when the lift force provided by the head propeller 202, the guide plate 203, the vehicle body propeller 204 and the bottom propeller 205 is greater than the gravity at full load, the flying vehicle 2 moves upwards in the upper duct, the sealing effect of the pressure bin in the lower duct is accordingly weakened, and the pressure intensity is reduced, such that the flying vehicle 2 gradually moves downwards. The sealing effect of the pressure bin in the lower duct is enhanced in the downward moving process, and the pressure intensity is increased, such that the flying vehicle 2 gradually moves upwards, and the flying vehicle 2 gradually reaches a self-steady operation state in the upward moving and downward moving adjustment process. In order to enhance the self-steady operation state of the flying vehicle 2 in the pipeline 1, in the invention, the pressure bins divided by the partition plate 102 are all pressure bins with the same structure and the same size; and the pipeline 1 in the invention is an equal-diameter pipe body.

In order to enhance the starting (corresponding to the ascending of the flying vehicle 2) and braking (corresponding to the descending of the flying vehicle 2) of the flying vehicle 2 in the pipeline 1, in the invention, preferably, a high-pressure tank is mounted inside a lower duct of the pipeline 1, so that when the vehicle tail of the flying vehicle 2 is located in front of the high-pressure tank, the high-pressure tank starts to discharge high-pressure gas, increasing the pressure intensity at the vehicle tail to enable the vehicle body to accelerate the ascending or starting; a low-pressure tank is mounted inside the lower duct of the pipeline 1, so that when the vehicle tail of the flying vehicle 2 runs behind the low-pressure tank before the descending or braking, the low-pressure tank at the bottom starts to discharge low-pressure gas, reducing the pressure at the vehicle head of the flying vehicle 2 to enable the flying vehicle 2 to decelerate so as to descend or brake.

When the flying vehicle 2 inclines left in the pipeline 1, the vehicle body propeller 204 is adjusted, such that the air pressure at the left is increased and the air pressure at the right is reduced, then the vehicle body deflects to the right. After the vehicle body deflects to the right, the air pressure at the left is reduced and the air pressure at the right is increased, such that the vehicle body inclines left, and gradually reaches a steady position.

When the flying vehicle 2 inclines left in the pipeline 1, the volume of the space between the left side of the flying vehicle 2 and the inner wall of the pipeline 1 is reduced, the pressure intensity therein is increased, and the volume of the space between the right side of the flying vehicle 2 and the inner wall of the pipeline 1 is increased, the pressure intensity therein is reduced, such that the flying vehicle 2 deflects to the right; and when the flying vehicle 2 deflects to the right, the volume of the space between the right side of the flying vehicle 2 and the inner wall of the pipeline 1 is reduced, the pressure intensity therein is increased, and the volume of the space between the left side of the flying vehicle 2 and the inner wall of the pipeline 1 is increased, the pressure intensity therein is reduced, such that the flying vehicle 2 deflects to the left. The above procedure repeats until the turning gradually reaches the condition that the volumes of the spaces of the left side and the right side of the flying vehicle 2 are the same, namely the pressure intensity at the left side and the right side are equal, and a steady state is achieved.

Specific embodiments of the invention are described in detail below. The various angles mentioned in the invention can be calculated by those skilled in the art using aeromechanics based on the actual dimensions of the vehicle body 201.

### Embodiment 1

The invention provides an operation system for an upper and lower double-duct jet-propelled pipeline ultra-high speed flying vehicle capable of realizing the operation method, which comprises a pipeline 1 and a flying vehicle 2;
the pipeline 1 comprises a bottom plate 101 which is disposed inside a pipeline body and divides a space inside the pipeline 1 into an upper duct and a lower duct, the lower duct below the bottom plate 101 is divided into a plurality of pressure bins by a partition plate 102, an edge of the bottom plate 101 is in sealing connection with the pipeline body of the pipeline 1, and a first opening 103 allowing airflow to come in and go out is disposed in a middle of the bottom plate 101 along a running direction, the first opening 103 being used as both an air suction channel and an air outlet channel which communicate the pressure bins with the upper duct;
the flying vehicle 2 comprises a vehicle body 201 with a side view projection being similar to a parallelogram and a front view projection being semicircular, a head tip of the vehicle body 201 gradually increases in width and transits to the vehicle body when seen from a top view direction, a tail of the vehicle body 201 gradually reduces in width from the vehicle body, the head tip of the vehicle body 201 is located at a lower portion of the vehicle body 201, two head propellers 202 are symmetrically disposed side by side in the middle of a head of the vehicle body 201, two tail propellers 206 are symmetrically disposed side by side in the middle of a tail of the vehicle body 201, a plurality of guide plates 203 are disposed side by side at a side edge of the vehicle body 201 along front-rear direction, a guide gap is formed between a plate body of the guide plates 203 and a vehicle body surface of the vehicle body 201, a joint between the plate body of the guide plates 203 and the vehicle body surface of the vehicle body 201 is gradually inclined towards the tail from up to down (as shown in FIG. 11), the plate body of the guide plates 203 gradually increases in width from up to down, an airflow inlet of the guide gap faces a head of the vehicle body 201, and the guide gap gradually increases in width from up to down; at least two vehicle body propellers 204 are disposed inside the guide gap, two rows of bottom propellers 205 are disposed side by side at a bottom of the vehicle body 201 along the front-rear direction, and a width of the vehicle body 201 occupied by the two rows of bottom propellers 205 together is matched with the first opening 103 (as shown in FIG. 11).

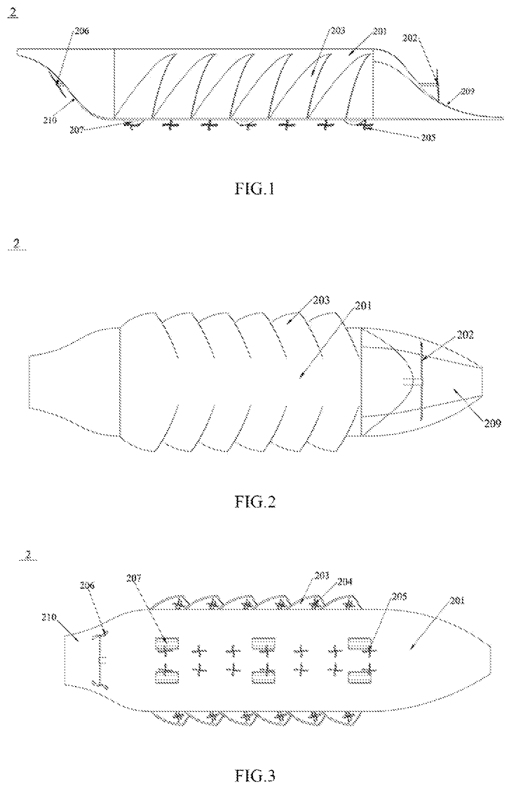

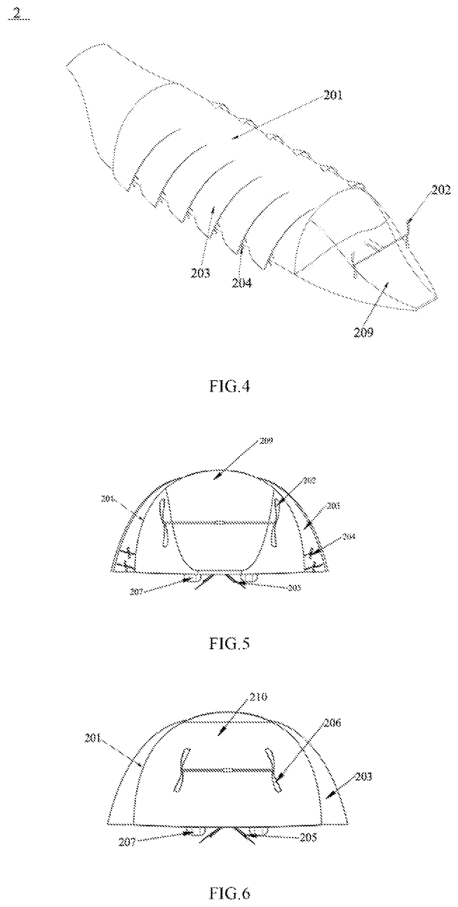

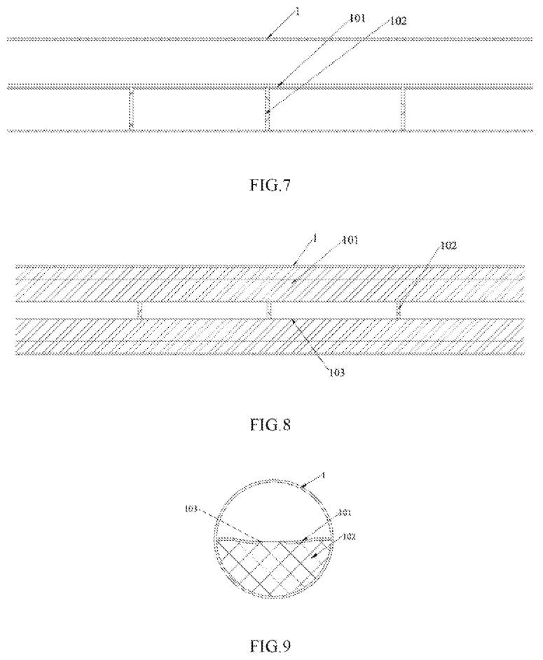

As shown in FIGS. 1 to 4, in this embodiment, a first arc-shaped concave surface 209 that guides and coordinates with the incoming flow is provided between the head tip and the head blunt portion of the vehicle body 201, and a second arc-shaped concave surface 210 that guides and coordinates with the high pressure airflow inside the lower duct is provided between the tail tip and the tail blunt portion of the vehicle body 201.

As shown in (a) of FIG. 10, during the air sucking, a head propeller 202 of the flying vehicle 2 compresses most of incoming flow at a vehicle head inside the upper duct to the lower duct through the air suction channel; a small portion of the airflow at the vehicle head is guided to the air suction channel by the guide plate 203 at the vehicle body of the flying vehicle 2; specifically, after entering through the airflow inlet of the guide gap, the airflow extends downwards and backwards along the guide gap, is guided by the vehicle body propeller 204, then is guided to the air suction channel (i.e. the first opening 103) by the bottom propeller 205 through the airflow outlet of the guide gap (the bottom of the guide plate 203), and then enters the pressure bins in the lower duct.

Further, the invention provides specific embodiments of the head propellers 202. As shown in FIG. 1, the two head propellers 202 each have a propeller body with two symmetrical forward and reverse paddles, the propeller bodies of the two head propellers 202 are located in the same plane, the plane where the propeller bodies of the two head propellers 202 are located is perpendicular to a length direction of the vehicle body 201, and the plane where the propeller bodies of the two head propellers 202 are located is perpendicular to the bottom plate 101.

As shown in (b) of FIG. 10, during the compressing, the bottom propeller 205 of the flying vehicle 2 compresses an airflow at the vehicle head and the vehicle body portion into the pressure bins of the lower duct at a lower portion of the flying vehicle 2 through the air suction channel. To facilitate the guidance of the airflow to the air suction channel, this embodiment also provides a specific structure of the bottom propeller 205. The two rows of bottom propellers 205 are symmetrically disposed at a central position of the bottom of the vehicle body 201, propeller bodies of the same row of bottom propellers 205 are located in the same plane, there is an angle between the planes where the propellers bodies of the two rows of bottom propellers 205 are located, and the angle between the planes where the propellers bodies of the two rows of bottom propellers 205 are located is disposed to be narrow at upper and wide at lower (as shown in FIG. 5).

Specifically, from the perspective of the right side of the flying vehicle 2, the airflow compressed into the pressure bins of the lower duct appears to flow in a direction from up to down, from front to back, and from down to up (clockwise direction); as shown in FIG. 11, from the perspective of the vehicle tail of the flying vehicle 2, the airflow compressed into the pressure bins of the lower duct appears to be from up to down (from a center of the air suction channel to a side wall of the pressure bins), from down to up along the side wall of the pressure bins, and from the side wall of the pressure bins to a center of the air outlet channel.

During the air jetting, as the bottom propeller 205 is not disposed at the vehicle tail of the flying vehicle 2, the dynamic sealing state of the pressure bins of the lower duct located at a tail portion of the flying vehicle 2 is destroyed, high-pressure airflow inside the lower duct is jetted out from the air outlet channel to the upper duct along the tail portion of the flying vehicle 2, and a tail propeller 206 of the flying vehicle 2 guides the airflow to the tail portion of the vehicle body, achieving a running of the flying vehicle 2 at an ultra-high speed in the pipeline 1.

Further, the invention provides a specific embodiment of the tail propellers 206. The two tail propellers 206 each have a propeller body with two symmetrical forward and reverse paddles, the propeller bodies of the two tail propellers 206 are located in the same plane, there is an angle between the plane where the propeller bodies of the two tail propellers 206 are located and the bottom plate 101, and lower portions of the propeller bodies of the two tail propellers 206 are inclined towards the head of the vehicle body 201.

In this embodiment, preferably, the body of the vehicle body 201 (rectangular region in the middle of the parallelogram) has a total length of 20 m, a height of 2.5 m, and a width of 3 m.

In order to improve the safety of the flying vehicle 2 in emergency situations such as emergency landing, etc., in this embodiment, two rows of wheels 207 are disposed side by side at the bottom of the vehicle body 201 along the front-rear direction, the bottom plate 101 close to the first opening 103 is inclined downwards towards a center of the first opening 103, and the two rows of wheels 207 are able to support and mate at an inclined position of the bottom plate 101. In this embodiment, the inclination of the bottom plate 101 can restrict the two rows of wheels 207, so that the vehicle body 201 is forced to travel along the centerline of the bottom plate 101, collision between the vehicle body and the side wall of the pipeline 1 due to an angle problem is avoided, and safety is greatly improved. In this embodiment, the wheels 207 are used only to provide support and guidance for the vehicle body 201, with rolling relationship between the wheels 207 and the bottom plate 101, dispensing with the need for powered traction. Preferably, the wheel 207 in this embodiment is made of a light material.

In order to facilitate the provision of power for various components such as various propellers on the flying vehicle 2, in the embodiment, the electric storage battery may be placed at the bottom of the vehicle body 1, so that the space of the vehicle body is fully utilized, and the heat dissipation of the battery in the working state is facilitated.

### Embodiment 2

The invention provides a specific embodiment of another operation system for an upper and lower double-duct jet-propelled pipeline ultra-high speed flying vehicle, which comprises a pipeline 1 and a flying vehicle 2;
the pipeline 1 comprises a bottom plate 101 which is disposed inside a pipeline body and divides a space inside the pipeline 1 into an upper duct and a lower duct, the lower duct below the bottom plate 101 is divided into a plurality of pressure bins by a partition plate 102, a spacing between an edge of the bottom plate 101 and the pipeline body of the pipeline 1 forms an air suction channel which communicates the pressure bins with the upper duct, and a second opening 104 allowing airflow to flow out from the pressure bins to the upper duct is disposed in a middle of the bottom plate 101 along a running direction, the second opening 104 being used as an air outlet channel which communicates the pressure bins with the upper duct;
the flying vehicle 2 comprises a vehicle body 201 with a side view projection being similar to a parallelogram and a front view projection being semicircular, a head tip of the vehicle body 201 gradually increases in width and transits to the vehicle body when seen from a top view direction, a tail of the vehicle body 201 gradually reduces in width from the vehicle body, the head tip of the vehicle body 201 is located at a lower portion of the vehicle body 201, two head propellers 202 are symmetrically disposed side by side in the middle of a head of the vehicle body 201, two tail propellers 206 are symmetrically disposed side by side in the middle of a tail of the vehicle body 201, a plurality of guide plates 203 are disposed side by side at a side edge of the vehicle body 201 along front-rear direction, a joint between a plate body of the guide plates 203 and a vehicle body surface of the vehicle body 201 is gradually inclined towards the tail from up to down, and the joint between the plate body of the guide plates 203 and the vehicle body surface of the vehicle body 201 gradually reduces in width from up to down, a guide plane that the plate body of the guide plates 203 forms gradually increases from up to down, at least one vehicle body propeller 204 is disposed in front of the vehicle body 201 corresponding to the guide plates 203, a row of bottom propellers 205 is separately disposed at a bottom of the vehicle body 201 outside both sides of the vehicle body 201 along the front-rear direction, and the two rows of bottom propellers 205 are respectively located corresponding to the air suction channel.

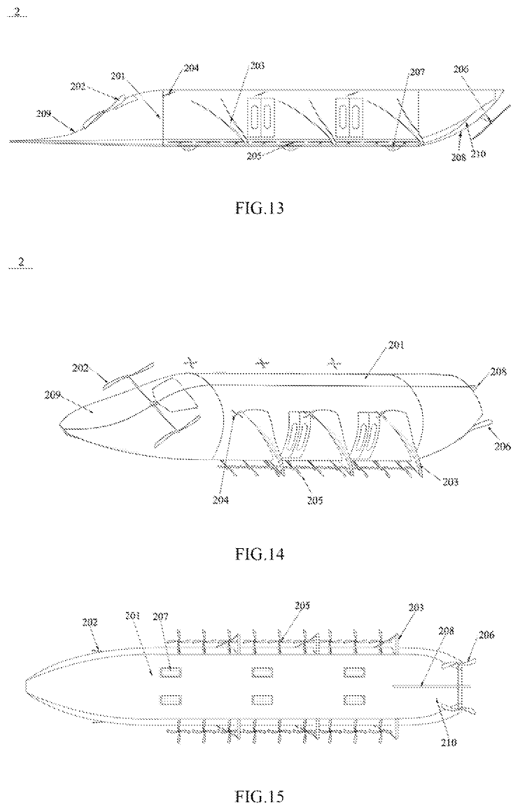

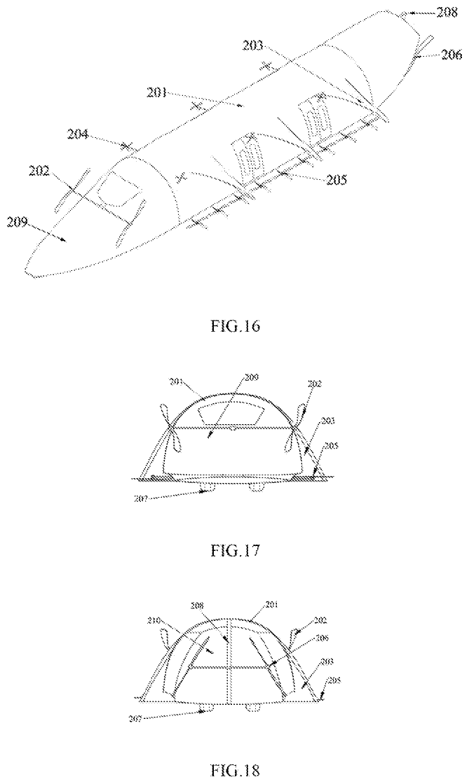

As shown in FIGS. 13 to 16, in this embodiment, a first arc-shaped concave surface 209 that guides and coordinates with the incoming flow is provided between the head tip and the head blunt portion of the vehicle body 201, and a second arc-shaped concave surface 210 that guides and coordinates with the high pressure airflow inside the lower duct is provided between the tail tip and the tail blunt portion of the vehicle body 201.

As shown in (a) of FIG. 23, during the air sucking, a head propeller 202 of the flying vehicle 2 compresses most of incoming flow at a vehicle head inside the upper duct to the lower duct through the air suction channel; a small portion of the airflow at the vehicle head is guided to the air suction channel by the guide plate 203 at the vehicle body of the flying vehicle 2; specifically, the airflow is guided to the guide plate 203 through the vehicle body propeller 204, extends downwards along the downward and backward guide surface of the guide plate 203, is then guided into the gap between the bottom plate 101 and the pipeline 1 by the bottom propeller 205, and further enters the pressure bins in the lower duct.

Further, this embodiment provides a specific embodiment of the head propellers 202. As shown in FIG. 1, the two head propellers 202 each have a propeller body with two symmetrical forward and reverse paddles, and the propeller bodies of the two head propellers 202 are located in the same plane, and there is an obtuse angle between the planes where the propeller bodies of the two head propellers 202 are located and an advancing direction of the vehicle body 201.

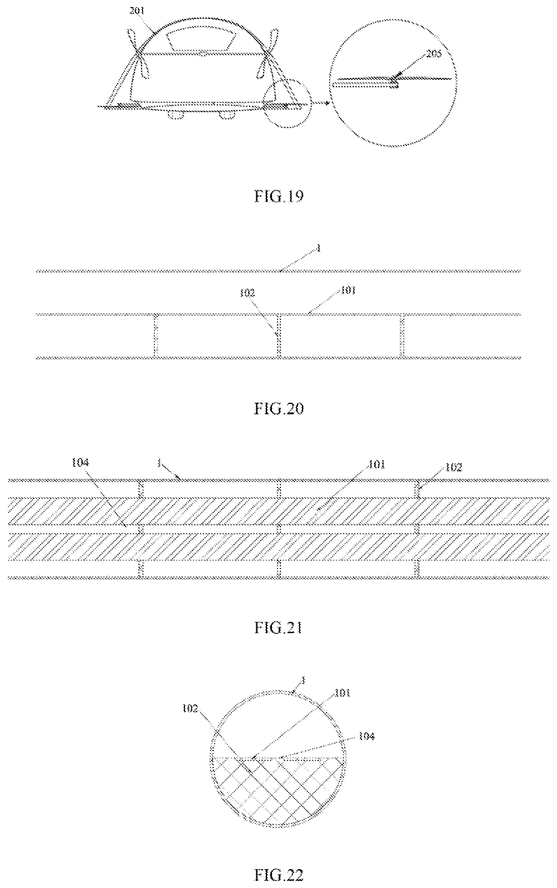

As shown in (b) of FIG. 23, during the compressing, the bottom propeller 205 of the flying vehicle 2 compresses an airflow at the vehicle head and the vehicle body portion into the pressure bins of the lower duct at a lower portion of the flying vehicle 2 through the air suction channel. To facilitate the guidance of the airflow to the air suction channel, this embodiment also provides a specific structure of the bottom propeller 205 (as shown in FIG. 19). The two rows of bottom propellers 205 are symmetrically located outside the bottom of the vehicle body 201, propeller bodies of the two rows of bottom propellers 205 are located in the same plane, and the plane where the propeller bodies of the two rows of bottom propellers 205 are located is parallel to the bottom plate 101. In this embodiment, one third of a propeller body of the bottom propeller 205 is located at the bottom of the vehicle body 201, and two thirds of the propeller body is located outside the vehicle body 201.

Specifically, from the perspective of the right side of the flying vehicle 2, the airflow compressed into the pressure bins of the lower duct appears to flow in a direction from up to down, from front to back, and from down to up (clockwise direction); as shown in FIG. 24, from the perspective of the vehicle tail of the flying vehicle 2, the airflow compressed into the pressure bins of the lower duct appears to be downwards from the above of a side wall of the pressure bins along the side wall, and appears to extend upward from a center of the bottom of the pressure bins to a center of the air outlet channel.

During the air jetting, as the bottom propeller is not disposed at the vehicle tail of the flying vehicle 2, the dynamic sealing state of the pressure bins of the lower duct located at a tail portion of the flying vehicle 2 is destroyed, high-pressure airflow inside the lower duct is jetted out from the air outlet channel to the upper duct along the tail portion of the flying vehicle 2, and a tail propeller 206 of the flying vehicle 2 guides the airflow to the tail portion of the vehicle body, achieving a running of the flying vehicle 2 at an ultra-high speed in the pipeline 1.

Further, the invention provides a specific embodiment of the tail propellers 206. The two tail propellers 206 each have a propeller body with two symmetrical forward and reverse paddles, the propeller bodies of the two tail propellers 206 are located in the same plane, and there is an obtuse angle between the plane where the propeller bodies of the two tail propellers 206 are located and an advancing direction of the vehicle body 201.

In this embodiment, in order to be matched with an aerodynamic structure of the vehicle tail of the flying vehicle 2 and guide the airflow to the vehicle tail, as shown in FIG. 18, a tail guide plate 208 is disposed in the middle of the vehicle tail of the flying vehicle 2 along the length direction. The tail guide plate 208 can divide the high pressure airflow jetted from the air outlet channel of the pressure cabins, and the divided airflow is guided to the vehicle tail by the corresponding tail propeller 206.

Preferably, two rows of wheels 207 are disposed side by side at the bottom of the vehicle body 201 along the front-rear direction, and the two rows of wheels are able to respectively support and mate with the bottom plate 101 at both sides of the second opening 104. In this embodiment, since the air suction channel and the air outlet channel are different channels, the middle of the bottom plate 101 does not need to be provided with an inclined structure which restrains and mates with the wheels 207, but in order to avoid friction between the vehicle body 201 and the bottom plate 101 in the lifting process, the wheels 207 are also disposed on the vehicle body 201 in this embodiment, and in this embodiment, the wheels 207 only play a supporting role, without the need for powered traction. As shown in FIG. 17, one third of the wheel body of the wheel 207 in this embodiment is located outside the vehicle body 201.

The foregoing is only specific embodiments of the invention to enable those skilled in the art to understand or implement the invention. Although described in detail with reference to the foregoing embodiments, it will be understood by those of ordinary skilled in the art that: the technical solutions described in the foregoing embodiments may be modified, or some or all of the technical features thereof may be replaced by equivalents; and these modifications or replacements do not depart the essence of the corresponding technical solutions from the scope of the technical solutions of the embodiments, which should all be covered within the protection scope of the claims.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Chinese application No. 202310664944.8, filed Jun. 7, 2023, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. An operation method for an upper and lower double-duct jet-propelled pipeline ultra-high speed flying vehicle, characterized in that,
S1: a space inside a pipeline (1) is divided into an upper duct and a lower duct by a bottom plate (101) in the pipeline (1), and the lower duct below the bottom plate (101) is divided into a plurality of pressure bins by a partition plate (102); a flying vehicle (2) runs in the upper duct, and an air suction channel and an air outlet channel which communicate the pressure bins with the upper duct are disposed in the bottom plate (101) along a running direction;
S2: the operation method comprises air sucking, compressing, and air jetting;
during the air sucking, a head propeller (202) of the flying vehicle (2) compresses most of incoming flow at a vehicle head inside the upper duct to the lower duct through the air suction channel; a small portion of airflow at the vehicle head is compressed to the lower duct through the air suction channel under an action of a guide plate (203) and a vehicle body propeller (204) at a vehicle body of the flying vehicle (2); and an airflow in a gap between a top of the flying vehicle (2) and the pipeline (1) is restrained by the gap and is always in a laminar flow state;
during the compressing, a bottom propeller (205) of the flying vehicle (2) compresses an airflow into the pressure bins of the lower duct at a lower portion of the flying vehicle (2) through the air suction channel, and a power provided by the bottom propeller (205) supplements energy loss in a flowing of the airflow and enables the pressure bins of the lower duct to be in a dynamic sealing state;
during the air jetting, the dynamic sealing state of the pressure bins of the lower duct located at a tail portion of the flying vehicle (2) is destroyed, high-pressure airflow inside the lower duct is jetted out from the air outlet channel to the upper duct along the tail portion of the flying vehicle (2), and a tail propeller (206) of the flying vehicle (2) guides the airflow to the tail portion of the vehicle body, achieving a running of the flying vehicle (2) at an ultra-high speed in the pipeline (1).

2. An operation system for an upper and lower double-duct jet-propelled pipeline ultra-high speed flying vehicle, characterized in that the operation system comprises a pipeline (1) and a flying vehicle (2);
the pipeline (1) comprises a bottom plate (101) which is disposed inside a pipeline body and divides a space inside the pipeline (1) into an upper duct and a lower duct, the lower duct below the bottom plate (101) is divided into a plurality of pressure bins by a partition plate (102), an edge of the bottom plate (101) is in sealing connection with the pipeline body of the pipeline (1), and a first opening (103) allowing airflow to come in and go out is disposed in a middle of the bottom plate (101) along a running direction, the first opening (103) being used as both an air suction channel and an air outlet channel which communicate the pressure bins with the upper duct;
the flying vehicle (2) comprises a vehicle body (201) with a side view projection being similar to a parallelogram and a front view projection being semicircular, a head tip of the vehicle body (201) gradually increases in width and transits to the vehicle body when seen from a top view direction, a tail of the vehicle body (201) gradually reduces in width from the vehicle body, the head tip of the vehicle body (201) is located at a lower portion of the vehicle body (201), two head propellers (202) are symmetrically disposed side by side in the middle of a head of the vehicle body (201), two tail propellers (206) are symmetrically disposed side by side in the middle of a tail of the vehicle body (201), a plurality of guide plates (203) are disposed side by side at a side edge of the vehicle body (201) along front-rear direction, a guide gap is formed between a plate body of the guide plates (203) and a vehicle body surface of the vehicle body (201), a joint between the plate body of the guide plates (203) and the vehicle body surface of the vehicle body (201) is gradually inclined towards the tail from up to down, the plate body of the guide plates (203) gradually increases in width from up to down, an airflow inlet of the guide gap faces a head of the vehicle body (201), the guide gap gradually increases in width from up to down; at least two vehicle body propellers (204) are disposed inside the guide gap, two rows of bottom propellers (205) are disposed side by side at a bottom of the vehicle body (201) along the front-rear direction, and a width of the vehicle body (201) occupied by the two rows of bottom propellers (205) together is matched with the first opening (103).

3. The operation system for an upper and lower double-duct jet-propelled pipeline ultra-high speed flying vehicle of claim 2, characterized in that two rows of wheels (207) are disposed side by side at the bottom of the vehicle body (201) along the front-rear direction, the bottom plate (101) close to the first opening (103) is inclined downwards towards a center of the first opening (103), and the two rows of wheels (207) are able to support and mate at an inclined position of the bottom plate (101).

4. The operation system for an upper and lower double-duct jet-propelled pipeline ultra-high speed flying vehicle of claim 2, characterized in that the two head propellers (202) each have a propeller body with two symmetrical forward and reverse paddles, and the propeller bodies of the two head propellers (202) are located in the same plane, the plane where the propeller bodies of the two head propellers (202) are located is perpendicular to a length direction of the vehicle body (201), and the plane where the propeller bodies of the two head propellers (202) are located is perpendicular to the bottom plate (101).

5. The operation system for an upper and lower double-duct jet-propelled pipeline ultra-high speed flying vehicle of claim 2, characterized in that the two tail propellers (206) each have a propeller body with two symmetrical forward and reverse paddles, the propeller bodies of the two tail propellers (206) are located in the same plane, there is an angle between the plane where the propeller bodies of the two tail propellers (206) are located and the bottom plate (101), and lower portions of the propeller bodies of the two tail propellers (206) are inclined towards the head of the vehicle body (201).

6. The operation system for an upper and lower double-duct jet-propelled pipeline ultra-high speed flying vehicle of claim 2, characterized in that the two rows of bottom propellers (205) are symmetrically disposed at a central position of the bottom of the vehicle body (201), propeller bodies of the same row of bottom propellers (205) are located in the same plane, there is an angle between the planes where the propellers bodies of the two rows of bottom propellers (205) are located, and the angle between the planes where the propellers bodies of the two rows of bottom propellers (205) are located is disposed to be narrow at upper and wide at lower.

7. An operation system for an upper and lower double-duct jet-propelled pipeline ultra-high speed flying vehicle, characterized in that the operation system comprises a pipeline (1) and a flying vehicle (2);
the pipeline (1) comprises a bottom plate (101) which is disposed inside a pipeline body and divides a space inside the pipeline (1) into an upper duct and a lower duct, the lower duct below the bottom plate (101) is divided into a plurality of pressure bins by a partition plate (102), a spacing between an edge of the bottom plate (101) and the pipeline body of the pipeline (1) forms an air suction channel which communicates the pressure bins with the upper duct, and a second opening (104) allowing airflow to flow out from the pressure bins to the upper duct is disposed in a middle of the bottom plate (101) along a running direction, the second opening (104) being used as an air outlet channel which communicates the pressure bins with the upper duct;
the flying vehicle (2) comprises a vehicle body (201) with a side view projection being similar to a parallelogram and a front view projection being semicircular, a head tip of the vehicle body (201) gradually increases in width and transits to the vehicle body when seen from a top view direction, a tail of the vehicle body (201) gradually reduces in width from the vehicle body, the head tip of the vehicle body (201) is located at a lower portion of the vehicle body (201), two head propellers (202) are symmetrically disposed side by side in the middle of a head of the vehicle body (201), two tail propellers (206) are symmetrically disposed side by side in the middle of a tail of the vehicle body (201), a plurality of guide plates (203) are disposed side by side at a side edge of the vehicle body (201) along front-rear direction, a joint between a plate body of the guide plates (203) and a vehicle body surface of the vehicle body (201) is gradually inclined towards the tail from up to down, the joint between the plate body of the guide plates (203) and the vehicle body surface of the vehicle body (201) gradually reduces in width from up to down, a guide plane that the plate body of the guide plates (203) forms gradually increases from up to down, at least one vehicle body propeller (204) is disposed in front of the vehicle body (201) corresponding to the guide plates (203), a row of bottom propellers (205) is separately disposed at a bottom of the vehicle body (201) outside both sides of the vehicle body (201) along the front-rear direction, and the two rows of bottom propellers (205) are respectively located corresponding to the air suction channel.

8. The operation system for an upper and lower double-duct jet-propelled pipeline ultra-high speed flying vehicle of claim 7, characterized in that two rows of wheels (207) are disposed side by side at the bottom of the vehicle body (201) along the front-rear direction, and the two rows of wheels are able to respectively support and mate with the bottom plate (101) at both sides of the second opening (104).

9. The operation system for an upper and lower double-duct jet-propelled pipeline ultra-high speed flying vehicle of claim 7, characterized in that the two head propellers (202) each have a propeller body with two symmetrical forward and reverse paddles, the propeller bodies of the two head propellers (202) are located in the same plane, and there is an obtuse angle between the plane where the propeller bodies of the two head propellers (202) are located and an advancing direction of the vehicle body (201).

10. The operation system for an upper and lower double-duct jet-propelled pipeline ultra-high speed flying vehicle of claim 7, characterized in that the two tail propellers (206) each have a propeller body with two symmetrical forward and reverse paddles, the propeller bodies of the two tail propellers (206) are located in the same plane, and there is an obtuse angle between the plane where the propeller bodies of the two tail propellers (206) are located and an advancing direction of the vehicle body (201).
